(19) United States
(12) Patent Application Publication
(10) Pub. No.: US 2026/0054610 A1
(43) Pub. Date: Feb. 26, 2026

(54) SLIDING BLOCK FOR A RAIL PAIR OF A LONGITUDINAL ADJUSTMENT DEVICE, AND RAIL PAIR COMPRISING SUCH A SLIDING BLOCK

(71) Applicant: Adient US LLC, Plymouth, MI (US)

(72) Inventors: Ingo QUAST, Düsseldorf (DE); Erik SPRENGER, Wermelskirchen (DE)

(21) Appl. No.: 19/308,686

(22) Filed: Aug. 25, 2025

(30) Foreign Application Priority Data
Aug. 26, 2024 (DE) 10 2024 208 104.3
Feb. 25, 2025 (DE) 10 2025 107 152.7

(51) Int. Cl. B60N 2/07

(52) U.S. Cl. CPC B60N 2/0705; B60N 2/0722

(57) ABSTRACT

A sliding block for a rail pair of a longitudinal adjustment device may have at least one base part having a lower sliding surface and an upper sliding surface. At least one of the sliding surfaces may have at least one flexible wedge segment arranged on the base part. In addition, the device relates to a rail pair.

### FIELD

The invention relates to a sliding block for a rail pair of a longitudinal adjustment device, and to a rail pair comprising such a sliding block.

### BACKGROUND

Different sliding blocks or ball cages for supporting a rail element in a profile of another rail element are known from the prior art. Sliding blocks or ball cages maintain the spacing between a movable rail element and a fixed rail element. In conventional practice, the spacing is set using a fixed measure. To avoid free play between the profiles of the rail elements, Z play is compensated by means of a spring. The disadvantage here is that a spring range of the spring is limited. For a total tolerance range, it is therefore necessary to provide several sliding block variants or cages, which are geometrically matched in such a way that the spring always operates in the optimum range, although it is not always possible to cover different spacings.

The problem to be solved by the invention is that of improving a sliding block of the type stated at the outset, in particular a sliding block for compensating tolerances, in particular different Z tolerances, for different rail systems, and of providing a rail pair.

### SUMMARY

According to the invention, the first mentioned problem is solved by means of a sliding block having the features in claim 1. According to the invention, the second mentioned problem is solved by means of a rail pair having the features of claim 14.

Advantageous embodiments, which can be used individually or in combination with one another, form the subject matter of the dependent claims.

The sliding block according to the invention for a rail pair of a longitudinal adjustment device comprises at least one base part having a lower sliding surface and an upper sliding surface, wherein at least one of the sliding surfaces comprises at least one flexible wedge segment arranged on the base part.

In particular, the sliding block can be designed as a self-adjusting slider, in particular a self-adjusting sliding bearing.

By virtue of the fact that at least one flexible wedge segment is provided on the base part, play or tolerances, in particular a Z play (also referred to as Z tolerances or vertical play) and/or X play (also referred to as X tolerances or longitudinal play) between the rails of a rail pair can be compensated in a self-acting manner. By virtue of its shape with a wedge surface and/or a mating wedge surface, the wedge segment can form a ratchet mechanism with another wedge segment. The design of the sliding block can be compact and optimized in terms of installation space. The wedge segment and the base part can be of integral design.

By means of a ratcheting effect of the wedge segment, which compensates tolerances, the sliding block, in particular the contact region thereof, is pressed by a spring force against a surface, in particular a rail surface of the rail pair, and is latched in the tolerance-compensating position by means of the locking mechanism, and therefore the sliding block is of self-adjusting design. As a result, the sliding block is of optimized design in respect of making sliding contact.

The flexible wedge segment can have at least one contact region, which extends parallel to the longitudinal extent of the base part, and a wedge surface or mating wedge surface which lies opposite the contact region and runs obliquely to said contact region, and/or a wedge surface or mating wedge surface which adjoins said contact region and runs obliquely to said contact region. The contact region can be formed by an outer edge, in particular an upper outer edge and/or a lower outer edge. In particular, the contact region can be formed by a rounded outer edge (also referred to as a surface or section) or by a curved outer edge. The contact region can form a sliding surface and/or a sliding section. The contact region is provided in order to contact and support a rail profile.

The at least one flexible wedge segment can be designed to be movable in the vertical extent of the base part. The flexible wedge segment can be or is brought lockably into engagement on a corresponding mating wedge surface on the base part or on another wedge segment.

The base part can have at least one further mating wedge surface, which corresponds to the wedge surface of the wedge segment and with which the wedge surface of the flexible wedge segment can be or is brought lockably into engagement.

The flexible wedge segment can be designed as a wedge segment which is inherently resilient or is arranged resiliently on the base part. In particular, the wedge segment of resilient design can be used to set a Z play and/or an X play in a self-acting manner. The at least one flexible wedge segment can be held on the base part in a manner preloaded in the vertical extent.

The sliding block, in particular the base part, can have a plurality of flexible wedge segments with mutually corresponding wedge surfaces and mating wedge surfaces.

The flexible wedge segments can comprise mutually facing stepped and/or toothed wedge surfaces and mating wedge surfaces, which can be or are brought lockably into engagement with one another.

The wedge surfaces and the mating wedge surfaces of two flexible wedge segments can be arranged one above the other in the vertical extent of the base part and so as to overlap at least in some section or sections. Here, the stepped and/or toothed wedge surfaces and mating wedge surfaces can act like a toothed nonreturn mechanism, a helically toothed locking mechanism or a ratchet mechanism, in particular a form-fit locking mechanism. The wedge segments can be pushed into one another in a first direction that cannot be opened again in an opposite, second direction. In this case, vertical flanks can be provided on the wedge surfaces and/or the mating wedge surfaces, and these stop a movement in the second direction in stages.

The flexible wedge segments can be movable relative to one another in the vertical extent and/or horizontal extent, in particular in the longitudinal extent, of the base part. For example, one of the wedge segments can be moved in the vertical extent relative to the other wedge segment, e.g. pushed downward or upward, and/or moved in the longitudinal extent, e.g. forward or backward over a range, in particular being pressed into locking engagement or being blocked with a locking action or being fixed in position by means of the locking engagement. The other wedge segment can be of fixed design in the vertical extent, e.g. being fixed in position or fixed in location. The other wedge segment can be additionally movable, e.g. slidable, in the longitudinal extent of the base part. The other flexible wedge segment can be held on the base part in a manner preloaded by a spring element in order to limit a movement in the longitudinal extent of the base part.

The flexible wedge segments can each be connected to the base part by a solid body joint. The flexible wedge segments can be configured to compensate tolerances, in particular Z tolerances, between two rails of the rail pair in a self-acting manner.

At least one of the flexible wedge segments can be connected to the base part by a four bar linkage. The four bar linkage can be formed by film joints. For example, the wedge segment that is flexibly movable in the vertical direction can be connected to the base part by a lateral four bar linkage.

At least one of the flexible wedge segments can be connected to the base part by elastically bendable attachment elements. For example, the wedge segment that is flexibly movable in the longitudinal direction can be connected to the base part by attachment elements that are elastically bendable in the longitudinal direction.

The base part can be designed as a shaped body and can have at least one upwardly open recess, on which at least one upper flexible wedge segment is arranged so as to project from one side of the recess. The upper flexible wedge segment can be arranged on the base part via a first, in particular lateral, solid body joint, e.g. a four bar linkage.

At least one lower flexible wedge segment can be arranged in a projecting manner on a lower side of the recess. The lower flexible wedge segment can be arranged on the base part via a second, in particular lower, solid body joint, which is formed by elastically bendable attachment elements, for example.

According to the invention, the first mentioned problem can be solved by a sliding block for a rail pair of a longitudinal adjustment device, comprising at least one base part having a lower sliding surface and an upper sliding surface, wherein at least the upper sliding surface comprises two flexible, e.g. resilient, wedge segments arranged on the base part, which can be or are brought into engagement with one another via mutually facing stepped and/or toothed mating wedge surfaces.

By virtue of the fact that at least the upper sliding surface comprises two wedge segments that are arranged resiliently on the base part and can be or are brought into engagement with one another via mutually facing stepped and/or toothed mating wedge surfaces, a Z play can be reduced by spring elasticity when a first rail element provided with the sliding block, e.g. a top rail, is pushed into a second rail element, e.g. a bottom rail. In particular, the wedge segments of resilient design can be used to set a Z play in a self-acting manner. By means of the stepped and/or toothed mating wedge surfaces, it is possible to set a Z play in stages in order to be able to compensate Z tolerances by way of an adjustment travel of the first rail element, e.g. a movable top rail, without jamming of the slider within the profiles of the rail elements.

The flexible wedge segments can each be designed as a wedge segment which is inherently resilient or is arranged resiliently on the base part.

Alternatively or optionally in addition, the lower sliding surface can comprise at least two flexible wedge segments arranged on the base part.

The sprung wedge segments can form a wedge pair, which are connectable or connected to one another via a stepped ratchet mechanism. The wedge segments can be arranged resiliently on the base part via solid body joints. As a result, production costs are low. At least one of the wedge segments can be preloaded by means of a spring element.

Such a sliding block, slider or sliding bearing is used, for example, to avoid brinelling in rail pairs. Moreover, there is an advantage in that a top rail provided with the sliding block can be used in rails with long adjustment travels while maintaining sufficient support for the top rail. In contrast to the use of ball cages, no relative movement can occur between the cage and the top rail with such a sliding block.

The sliding block is configured to ensure support for the top rail within a profile of the bottom rail in a downward and also in an upward direction.

The sliding block is used to form a sliding mechanism which comprises at least one base part, which extends substantially in the longitudinal direction and has a lower sliding surface and an upper sliding surface in the vertical direction, wherein the lower sliding surface is fixed, and the upper sliding surface has two wedge segments resiliently mounted on the base part for the automatic setting of a Z play between two rail elements.

The advantages achieved by means of the invention consist, in particular, in that the sliding mechanism is of ball-free design, and therefore plastic deformations are reliably avoided. Such a sliding block is simple to assemble.

According to the invention, the second mentioned problem is solved by a rail pair for a longitudinal adjustment device of a vehicle seat, comprising at least one first rail element, a second rail element and a sliding block according to the above description. The sliding block can be pre-installed on the first rail element, e.g. a movable rail, in particular a top rail. As the first rail element is pushed into the second rail element, e.g. a fixed rail, in particular a bottom rail, the resilient wedge segments can be brought into engagement with one another via their corresponding stepped and/or toothed mating wedge surfaces for the self-acting or automatic setting of a Z play between profiles of the rail elements.

The respective sliding block can be of shorter design than the top rail profile. In an alternative embodiment, the length of the respective sliding block can extend along the entire length of a top rail profile. In the case of a design extending over the entire length of the top rail profile, the sliding block can have a plurality of recesses and a plurality of flexible wedge segments distributed over the base part.

One of the rail elements can be movably coupled and adjustable relative to the other rail element via the sliding block, wherein the sliding surfaces of the sliding block are respectively arranged in an upper track and a lower track between the rail elements or the rail profiles thereof.

The wedge segments can each extend parallel to the tracks.

In cross section, the sliding block, in particular the base part, can be a substantially J-shaped or U-shaped design.

### DESCRIPTION OF THE FIGURES

The invention is explained in greater detail below by means of advantageous exemplary embodiments illustrated in the figures. However, the invention is not restricted to these exemplary embodiments. In the drawing:

FIG. 1: shows a vehicle seat having a longitudinal adjustment device in schematic illustration,

FIG. 2: shows a section through a rail pair along the line II-II in FIG. 1,

FIG. 3: shows a perspective view of a first rail element, in particular a top rail,

FIG. 4: shows a perspective view of the first rail element with a sliding block according to the invention,

FIG. 5: shows a side view of the first rail element with the sliding block according to the invention,

FIG. 6: shows a side view of the sliding block according to the invention,

FIGS. 7 to 9: show detail side views of a tightening process of the sliding block according to the invention,

FIGS. 10 and 11: show schematic and detail views of a locking sequence of wedge surfaces and mating wedge surfaces of the sliding block according to the invention,

FIG. 12: shows a side view of a sliding block according to the invention in accordance with another exemplary embodiment,

FIG. 13: shows a perspective view of a sliding block according to the invention in accordance with another exemplary embodiment, and

FIG. 14: shows a section through the sliding block according to the invention along the line XIV-XIV in FIG. 13.

### DETAILED DESCRIPTION

Parts that correspond to one another are provided with the same reference signs in all the figures.

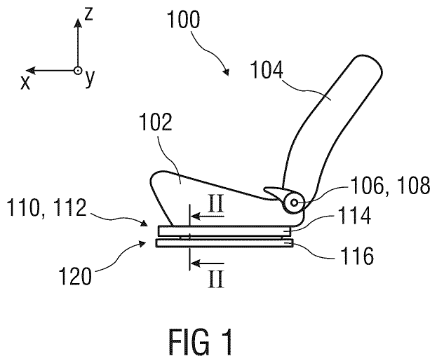

A vehicle seat 100 illustrated schematically in FIG. 1, relating to the prior art, is described below using three spatial directions running perpendicular to one another. With a vehicle seat 100 installed in the vehicle, a longitudinal direction x runs largely horizontally and preferably parallel to a vehicle longitudinal direction, which corresponds to the usual direction of travel of the vehicle. In the vehicle, a transverse direction y running perpendicularly to the longitudinal direction x is likewise aligned horizontally and runs parallel to a vehicle transverse direction. A vertical direction z runs perpendicularly to the longitudinal direction x and perpendicularly to the transverse direction y. In the case of a vehicle seat 100 installed in the vehicle, the vertical direction z preferably runs parallel to a vehicle vertical axis.

The position indications and direction indications used, e.g. front, rear, up and down refer to a direction of view of an occupant sitting in the vehicle seat 100 in a normal sitting position, wherein the vehicle seat 100 is installed in the vehicle and aligned in a position of use suitable for carrying people, with the seat back 104 upright, and as normal in the direction of travel. However, the vehicle seat 100 may also be installed or moved in a different alignment, e.g. transversely to the direction of travel. Unless described otherwise, the vehicle seat 100 is constructed in mirror symmetry with a plane running perpendicularly to the transverse direction y.

The seat back 104 can be arranged pivotably on a seat part 102 of the vehicle seat 100. For this purpose, the vehicle seat 100 can optionally comprise a fitting 106, in particular an adjustment fitting, rotation fitting, latching fitting or tilt fitting.

The position indications and direction indications used, such as radial, axial and in the circumferential direction, refer to an axis of rotation 108 of the fitting 106. Radial means perpendicular to the axis of rotation 108. Axial means in the direction of or parallel to the axis of rotation 108.

The vehicle seat 100 can optionally comprise a longitudinal adjustment device 110. The longitudinal adjustment device 110 comprises, for example, a rail arrangement 112, e.g. a rail pair 120, having a first rail element 114 and a second rail element 116. The first rail element 114 is adjustable relative to the second rail element 116 in the longitudinal direction x. The first rail element 114 is secured on the seat part 102.

The second rail element 116 is secured on a structural element of a vehicle, e.g. a vehicle floor.

For greater clarity, the first rail element 114 is referred to as the top rail 114 in the following description. This top rail 114 (also referred to as a running rail or slide) is assigned to the vehicle seat 100 and configured to support this vehicle seat 100. The second rail element 116 is referred to below as the bottom rail 116. The bottom rail 116 is connected in a fixed manner and by way of example to the floor of a vehicle.

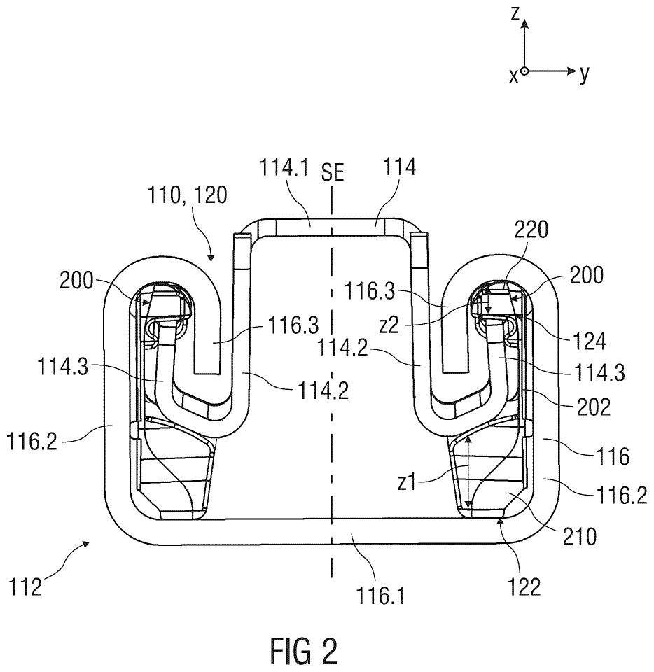

FIG. 2 shows a section, e.g. a profile view, through a rail pair 120 along the line II-Il in FIG. 1.

The bottom rail 116, in particular a bottom rail profile, has a bottom rail base 116.1 and, on each side of a plane of symmetry SE, a bottom rail flank 116.2 at an angle to the bottom rail base 116.1, and a bottom rail end section 116.3 angled inward, i.e. toward the plane of symmetry SE, and downward, i.e. toward the bottom rail base 116.1, from the bottom rail flank 116.2.

The top rail 114, in particular a top rail profile, has a top rail central section 114.1 and, on each side of the plane of symmetry SE, a top rail flank 114.2 at an angle to the top rail central section 114.1, and a top rail end section 114.3 angled outward, i.e. away from the plane of symmetry SE, and upward, i.e. away from the top rail base 116.1, from the top rail flank 114.2. The top rail central section 114.1 runs parallel to the bottom rail base 116.1, above the lower rail profile. Each top rail flank 114.2 has a region which runs between the bottom rail end sections 116.3. Each top rail end section 114.3 projects into a spatial region which is situated between a bottom rail flank 116.2 and the bottom rail end section 116.3 at an angle to the latter. The rail profiles fit around one another.

The bottom rail 116 and the top rail 114 are each manufactured from a metallic material, for example.

To avoid brinelling (groove formation or trough formation, a wear phenomenon on rolling bearings, for example), a number of sliding blocks 200 and optionally in addition other sliding elements can be arranged along the longitudinal extent of the rail pair 120.

The sliding blocks 200 are used in rail arrangements 112 with, for example, long adjustment travels in order to allow adequate support for the top rail 114 in the bottom rail 116. In contrast to ball cages, there are no relative movements here between a cage and the top rail 114.

The purpose of the sliding blocks 200 is not only to support the top rail 114 in a downward direction but also to support the top rail 114 in an upward direction. Each sliding block 200 comprises at least one base part 202, a lower sliding surface 210 and an upper sliding surface 220.

The base part 202 is arranged between the flanks of the top rail 114 and the bottom rail 116. As a result, the top rail 114 is coupled movably to the bottom rail 116 and is adjustable relative to the latter. The sliding surfaces 210, 220 are arranged respectively in a lower and an upper track 122, 124.

The lower sliding surface 210 and the upper sliding surface 220 support the top rail 114 on the bottom rail 116. In the respective flank regions between the top rail 114 and the bottom rail 116, a lower first spacing z1 and an upper second spacing z2 are formed. By means of the sliding blocks 200, it is possible for the lower first spacing z1 between the top rail 114 and the bottom rail 116 to be kept very largely constant.

The sliding blocks 200 are arranged laterally on the outer top rail end sections 114.3. During the assembly of the seat rail pair 120, the top rail 114 with the laterally applied sliding blocks 200 and the bottom rail 116 are inserted one inside the other and pushed together.

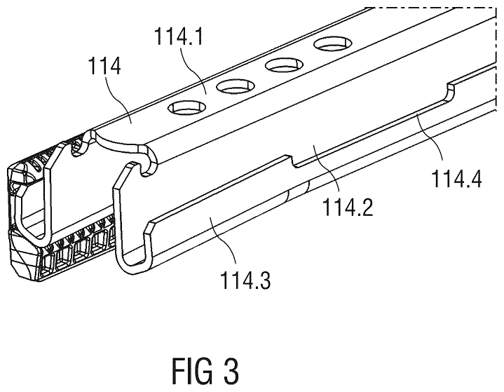

FIG. 3 shows a perspective view of a first rail element 114, in particular a top rail 114.

The top rail 114 can comprise a plurality of recesses 114.4 in the region of its respective top rail end section 114.3. For example, at least one recess 114.4 can be provided in each of the rail end regions. The top rail 114 can have four recesses 114.4 in the top rail profile, e.g. along its longitudinal extent. The respective recess 114.4 is configured to be connected to a self-adjusting sliding block 200 according to the invention, which minimizes the Z play.

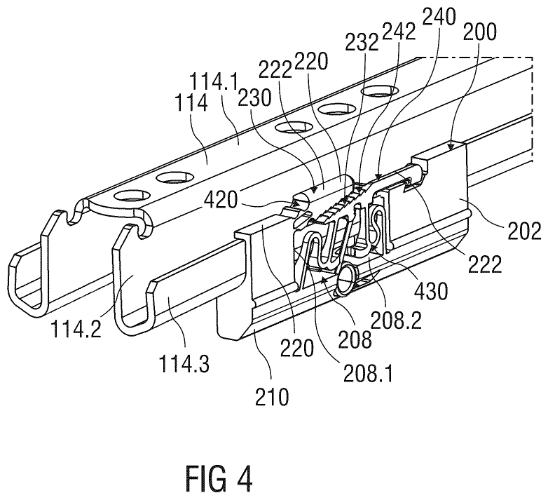

FIG. 4 shows a perspective view of the first rail element 114, in particular top rail 114, with a sliding block 200 according to the invention.

An upper second spacing z2 may differ on account of rail tolerances, e.g. production tolerances. To avoid free play here, at least one resilient element must be employed. Selective assembly in production may prove difficult since the tolerance statuses of the combined rail profiles are not known and not constant. Conventionally, it is thus necessary to select one slider version for paired production batches with known tolerances. Moreover, 100% measurement of play is necessary after installation in order to keep the Z play as small as possible and to always select the appropriate slider version.

The sliding block 200 according to the invention is designed as a self-adjusting slider which minimizes the Z play and is configured in such a way as to ensure that no jamming can occur.

For this purpose, the sliding block 200 comprises a base part 202, in particular a base body, a lower sliding surface 210 and an upper sliding surface 220, wherein at least the upper sliding surface 220 comprises two wedge segments 230, 240 arranged resiliently on the base part 202, which can be or are brought into engagement with one another via mutually facing stepped and/or toothed wedge surfaces 232, 242. The wedge surfaces 232, 242 (also referred to as mutually corresponding locking surfaces/teeth or mutually corresponding oblique surfaces/teeth) are designed as mutually corresponding wedge surfaces 232 or 242 and mating wedge surfaces 242 or 232. For greater clarity, the wedge surfaces 232 or 242 and mating wedge surfaces 242 or 232 are referred to as wedge surfaces 232, 242.

In an exemplary embodiment that is not illustrated in detail, the lower sliding surface 210 can, as an option, additionally or alternatively comprise at least two flexible, in particular resilient, wedge segments 230, 240 arranged on the base part 202.

In particular, the wedge segments 230, 240 are of flexible design. The wedge segments 230, 240 can each be designed as a wedge segment 230, 240 which is inherently resilient or is arranged resiliently on the base part 202. In the exemplary embodiment illustrated, one of the wedge segments 230, in particular an upper wedge segment 230, is arranged on the base part 202 via a lateral first solid body joint 430. Another of the wedge segments 240, in particular a lower wedge segment 240, is arranged on the base part 202 via a lower second solid body joint 430.

The base part 202 is designed as a shaped body and/or block-type body. The base part 202 comprises at least one upwardly open recess 208, into which the wedge segments 230, 240 project at least partially. The upper flexible wedge segment 230 is arranged so as to project from one side 208.1 of the recess 208. The lower flexible wedge segment 240 is arranged so as to project from a lower side 208.2 of the recess 208. The upper flexible wedge segment 230 is connected to the side 208.1 of the recess 208 via the lateral first solid body joint 420. The lower flexible wedge segment 240 is connected to the lower side 208.2 of the recess 208 via the lower second solid body joint 420.

In one embodiment, the base part 202 and the sliding surfaces 210, 220 are designed as a one-piece sliding body, sliding bearing or sliding mechanism.

By means of the wedge segments 230, 240, the Z play can be reduced by spring elasticity, wherein, by means of the stepped and/or toothed wedge surfaces 232, 242, the upper sliding surface 220 can be adapted in stages or stage-wise to the tolerances and/or the spacing z2, depending on the Z tolerances or spacing z2. By means of the resilient wedge segments 230, 240, Z tolerances can be compensated for by way of the adjustment travel of the top rail 114 without the sliding block 200 jamming within the profiles. This mechanism can be positioned at four points in a top rail 114, for example, or at two points within a slider, in each case at the ends of the top rail 114. A number of sliding surfaces 220 and/or wedge segments 230, 240 can vary, depending on the length of the sliding block 200.

The upper sliding surface 220 comprises at least one contact region 222. The contact region 222 is formed by one of the wedge segments 230, 240. The contact region 222 is arranged on a side of the same wedge segment 230, 240 which faces away from a step system and/or tooth system of the wedge segment 230, 240. The contact region 222 has a rounded or curved surface. The contact region 222 can be designed as a sliding section formed, in particular molded, as a semicircle.

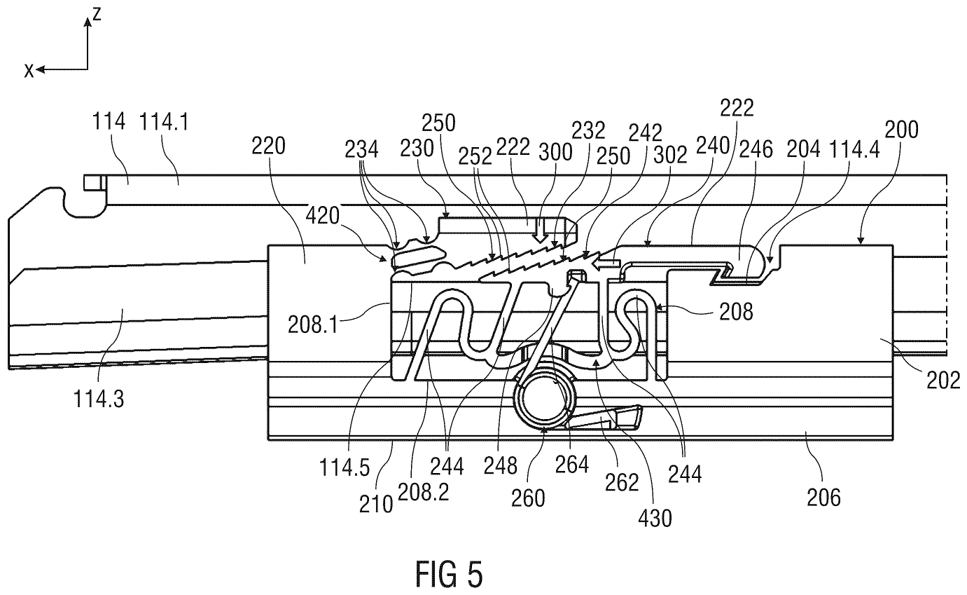

FIG. 5 shows a side view of the first rail element 114, in particular the top rail 114, with the sliding block 200.

The wedge segments 230, 240 are arranged one above the other in the vertical direction z and so as to overlap in some section or sections, wherein the wedge surfaces 232, 242 face one another.

The upper flexible wedge segment 230 has at least one contact region 222, which extends parallel to the longitudinal extent of the base part 202, and a wedge surface 232 which lies opposite the contact region 222 and runs obliquely to the latter.

The lower flexible wedge segment 240 has at least one corresponding oblique wedge surface 242 which faces the wedge surface 232 of the upper wedge segment 230. On a side situated opposite the wedge surface 242 of the lower wedge segment 240, the lower wedge segment 240 has the lower second solid body joint 430, via which the lower wedge segment 240 is held on the base part 202 so as to be movable in the longitudinal extent.

During assembly, namely as the top rail 114, together with additional sliding elements, is pushed in in the vertical direction z, see arrow 300, the upper wedge segment 230 is pressed down against the forces acting by virtue of film joints 234. After this, the lower wedge segment 240 is displaced in the longitudinal direction x, see arrow 302, by way of a spring force against the upper wedge segment 230.

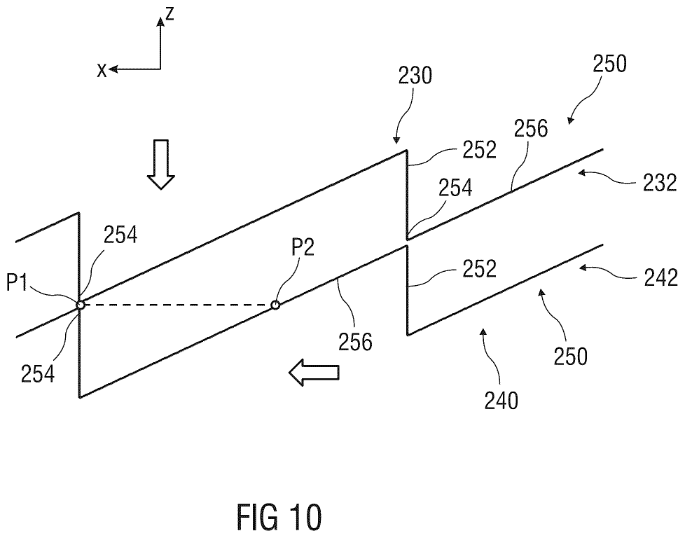

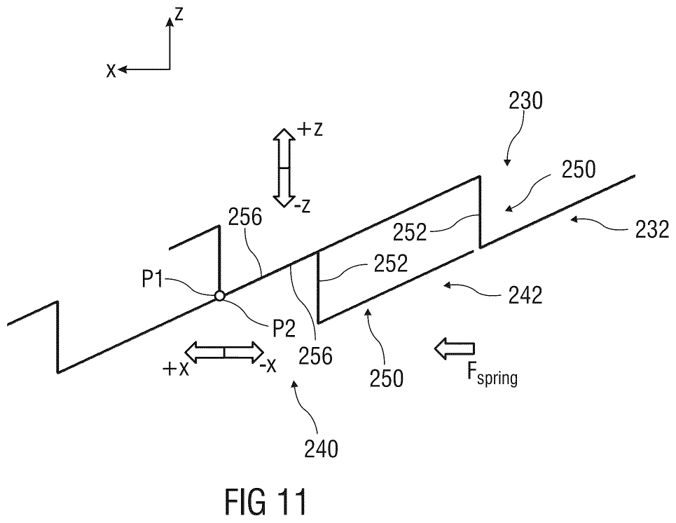

During this process, the lower wedge segment 240 slides on an edge 114.5 of the recess 114.4. Via the bevels of the wedge segments 230, 240, a Z force acts on the top rail profiles and the bottom rail profiles and ensures freedom of play by means of a spring force. In this case, the stepped and/or toothed wedge surfaces 232, 242 act like a locking mechanism, in particular a ratchet mechanism, a toothed nonreturn mechanism or the like. The wedge segments 230, 240 can be pushed one inside the other but cannot be opened again in the other direction since vertical flanks 252 of the respective tooth system 250 of the wedge segments 230, 240 stop this movement in a stepped manner (shown in detail in FIGS. 10 and 11).

The upper wedge segment 230 is arranged resiliently on the base part 202 via at least one film joint 234, in this case a plurality of integrally formed film joints 234. The lower wedge segment 240 is connected to the base part 202 via at least one elastically bendable attachment element 244, in this case an arrangement consisting of attachment elements 244. The attachment element 244 is, for example, a leg or arm of elastically bendable design, in particular a spring leg or spring arm. By means of the elastically bendable attachment elements 244, the lower wedge segment 240 can be designed to be movable in the longitudinal direction.

The upper wedge segment 230 can be articulated resiliently in an upper section of the base part 202. The lower wedge segment 240 can be connected to a lower section of the base part 202 via the attachment element 244 or the attachment elements 244. The lower wedge segment 240 comprises a gripping element 246, e.g. a hook, which engages in a mating gripping element 204, e.g. a hook, a groove or recess with a protuberance, on the base part 202 in order to limit a movement path of the lower wedge segment 240 relative to the base part 202 in the longitudinal direction x.

In other words: the base part 202 can have a first wedge segment 230 which is movable in the vertical extent and immovable in the longitudinal extent. The base part 202 can have a second wedge segment 240 which is immovable in the vertical extent and movable in the longitudinal extent. Alternatively, at least one of the wedge segments 230 or 240 or both wedge segments 230, 240 can be movable or flexible in the vertical extent, in particular in the vertical direction z, and in the longitudinal extent, in particular in the longitudinal direction x.

The first, in particular upper, wedge segment 230 is designed to be flexible in the vertical direction. The second, in particular lower, wedge segment 240 is designed to be flexible in the longitudinal direction.

The first wedge segment 230 is designed to be fixed in the longitudinal direction and flexible in the vertical direction. The second wedge segment 240 is designed to be flexible in the longitudinal direction and fixed in the vertical direction.

The sliding block 200 can be formed from a plastic part, which can be produced by means of a simple open and shut mold. The sliding block 200 or a sliding block assembly comprises at least one spring element 260, e.g. a metal spring and/or a torsion spring. The spring element 260 is held clamped on the base part 202. The spring element 260 comprises a first spring leg 262, which is supported within the sliding block 200 in the region of a sliding block base 206. The spring element 260 comprises a second spring leg 264, which is operatively connected to the lower wedge segment 240. The lower wedge segment 240 comprises, for example, a spring connection point 248, e.g. in the form of a hook. The spring element 260 can be arranged in a region of the sliding block base 206. It is thereby possible to save installation space. It is also possible here to use springs of different strengths. By way of the wedge angle and the spring rate, it is possible to define displacement forces and to keep them relatively constant, irrespective of tolerances.

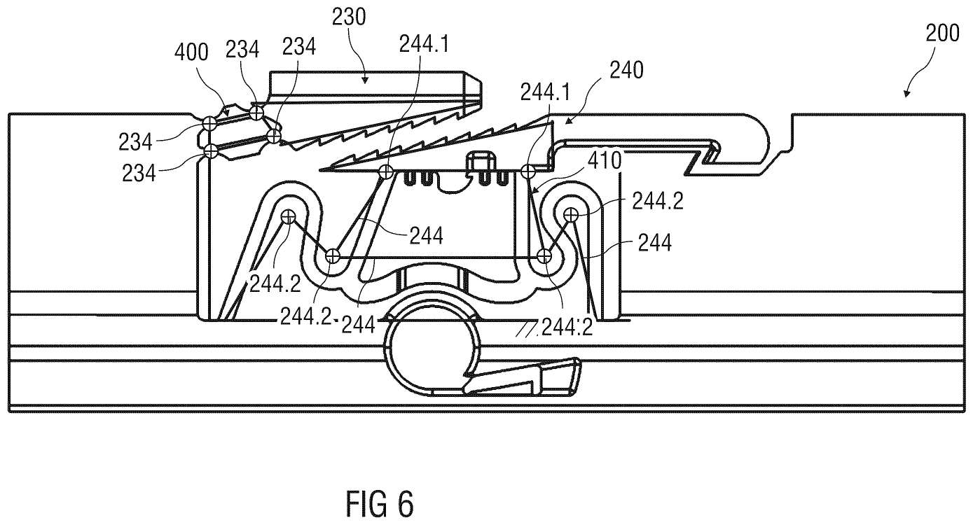

FIG. 6 shows a side view of the sliding block 200.

The directions of movement of the wedge segments 230, 240 are implemented by means of solid body joints. The upper wedge segment 230 can be moved vertically and does not perform any rotation during this process, instead being held parallel to the slideway or track 122, 124 of the bottom rail 116 by means of a four bar linkage 400. This four bar linkage 400 is implemented by means of film hinges 234. The lower wedge segment 240 can be connected to ends of the elastically bendable attachment elements 244 via bending points 244.1 and/or hinges. The attachment elements 244 can be connected to one another by further bending points 244.2. The attachment elements 244 can be meander-shaped in order to provide a spring force.

The lower wedge segment 240 can primarily perform a linear movement, this being achieved via kinematics 410, e.g. multi-joint kinematics, of the elastically bendable attachment elements 244. The solid body joints 420, 430 make it possible to introduce the required freedom of movement within a plastic part.

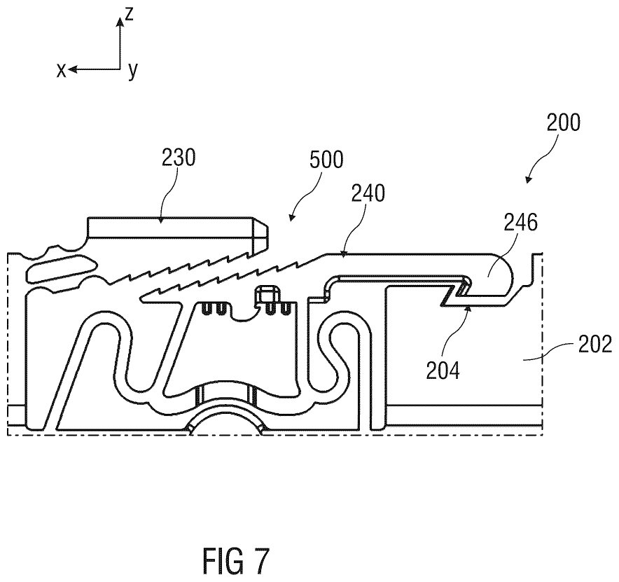

FIGS. 7 to 9 show detail side views of a tightening process of the sliding block 200.

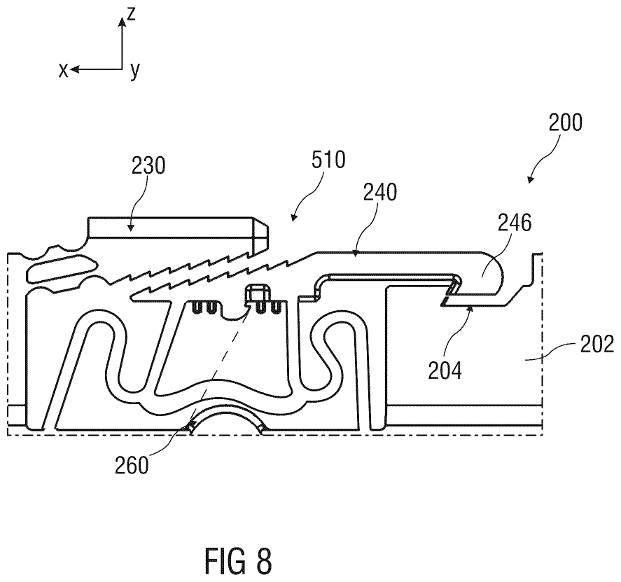

FIGS. 7 to 9 show an assembly movement of the wedge segments 230, 240. In FIG. 7, the upper wedge segment 230 has not yet been displaced downward, as would be the case after assembly. The movement of the lower wedge segment 240 can take place upon contact with the upper wedge segment 230. In particular, the movement of the lower wedge segment 240 takes place after the release of its hook, in particular after the release of engagement of the gripping element 246. After enablement of play, the movement of the lower wedge segment 240 is stopped. FIG. 7 shows an initial state 500, e.g. a production state, of the sliding block 200. FIG. 8 shows a preloaded state 510 of the sliding block 200, which is already arranged on a rail element 114, with the spring element 260 hooked in. The gripping element 246 of the lower wedge segment 240 ensures that the lower wedge segment 240 cannot be moved further in the longitudinal direction x, wherein the gripping element 246 is in engagement with the mating gripping element 204 on the base part 202.

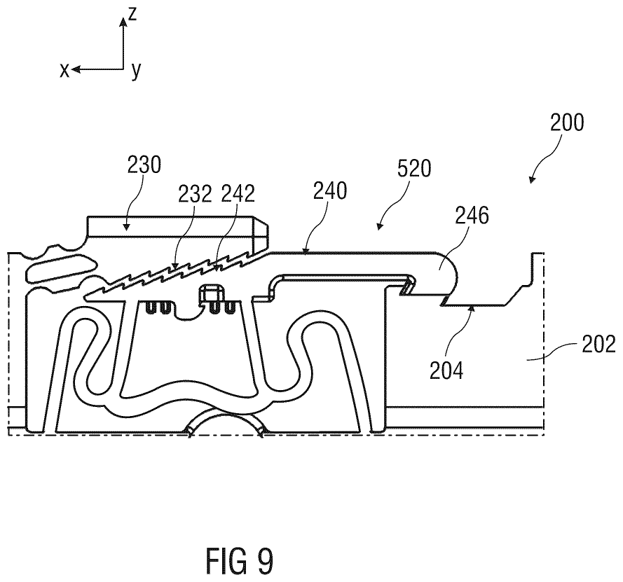

FIG. 9 shows the sliding block 200 just before a final assembly state of the sliding block 200. When the lower wedge segment 240 is moved further, the wedge surfaces 232, 242 of the wedge segments 230, 240 are brought into engagement with one another and form a locking mechanism in the final assembly state. A linear wedging movement in the longitudinal direction x should take place only after the insertion of the top rail 114 with the sliding block 200 into the bottom rail 116. For this purpose, the gripping element 246 is pushed in the transverse direction y until the engagement of the gripping element 246 is lost. This can be accomplished by means of a hole pattern in the bottom rail 116, by means of which all the gripping elements 246, in particular hooks, of the sliders used can be pushed aside.

FIGS. 10 and 11 show schematic and detail views of a locking sequence of mating wedge surfaces 232, 242 of the sliding block 200.

The locking sequence corresponds to that of a toothed nonreturn mechanism, for example. In a limiting case illustrated in FIG. 10, in which the tooth tips 254 of the individual wedge teeth 256 meet, the lower wedge segment 240 is pushed further until point P2 of the lower wedge segment 240 meets point P1 of the upper wedge segment 230. In this position according to FIG. 11, it is then possible to compensate Z movements of the upper wedge segment 230, which occur when an adjustment travel, corresponding to the spacing z2 (illustrated in FIG. 2), changes. If, for example, the spacing z2 for the slider in the bottom rail 116 becomes larger, the upper wedge segment 230 moves in direction +z. The lower wedge segment 240 is then adjusted further in direction +x by the spring force “Fspring”. If the spacing z2 (illustrated in FIG. 2) in the bottom rail profile becomes smaller, the upper wedge segment 230 is displaced in a direction −z, and the lower wedge segment 240 is displaced in the −x direction against the spring force Fspring until the vertical flanks 252 of the tooth systems 250 meet. Here, the angles and lengths of the tooth systems 250 on the wedge segments 230, 240 are configured in such a way that limitation by way of the vertical flanks 252 is not achieved on account of tolerances, but is achieved only in the case of active raising of the top rail 114. This can lead to a relative displacement of the wedges, wherein the Z play of the top rail 114 in the bottom rail 116 is actively limited by way of the vertical flanks 252.

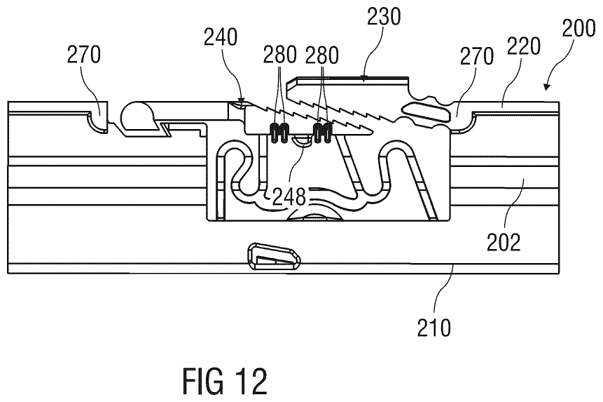

FIG. 12 shows a side view of a sliding block 200 in accordance with another exemplary embodiment.

The sliding block 200 can comprise a number of catches 270, which ensure synchronous movement with the top rail 114. These lie laterally in the recess 114.4 of the top rail 114. The sliding block 200 can comprise a number of hook elements 280 which ensure lateral guidance of the lower wedge segment 240 and also better pre-installation of the sliding block 200 on the top rail 114 since they are held in position before the insertion of the top rail 114 with the sliding block 200 into the bottom rail 116. A spring connection point 248 arranged centrally in the direction of longitudinal extent of the wedge segment 240 can be provided on the lower wedge segment 240. The spring connection point 248 is an interface for spring legs 262, 264 of a spring element 260. The spring connection point 248 can have a lateral collar to ensure that the spring element 260 can always remain in contact with the wedge segment 240 and cannot disengage laterally.

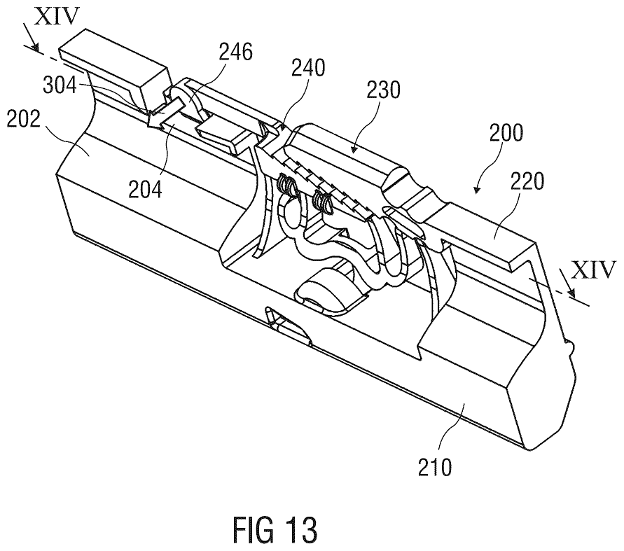

FIG. 13 shows a perspective view of a sliding block 200 in accordance with another exemplary embodiment.

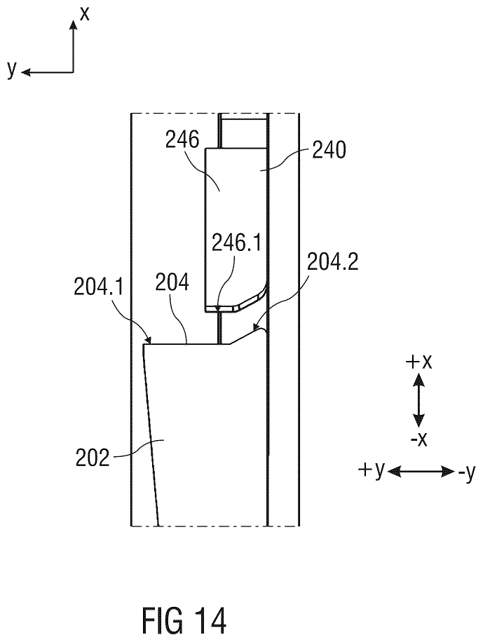

FIG. 14 shows a detail of the sliding block 200 in section along the line XIV-XIV in FIG. 13.

The gripping element 246 of the lower wedge segment 240 can be designed to be resistant to incorrect release since the leg spring 262, 264 can be already under maximum stress and connected to the wedge segment 240 before installation. Installation with a released spring would not be possible. In order to disengage the gripping element 246 from the mating gripping element 204 of the base part 202, it must be pushed a long way in the transverse direction y, see arrow 304. This is achieved by means of a long contact surface 204.1. The gripping element 246, in particular a hook, is illustrated without a spring preload. As soon as the spring element 260 is tensioned, the gripping element 246 comes into contact by means of its contour 246.1 with a mating contour on the mating gripping element 204, formed by the contact surfaces 204.1 (linear) and 204.2 (sloping). The sloping or oblique contact surface 204.2 interacts with the gripping element 246 in a self-locking manner with respect to movements in the −y direction. In the +y direction too, the straight or linear contact surface 204.1 has a self-locking action since, to cover the distance in the +y direction, the spring hook is displaced in the +x direction, in the tensioning direction of the spring element 260. This configuration ensures great insensitivity to shocks on the preassembly group consisting of the plastic main body of the base part 202 and the tensioned spring element 260. The cross sections of the gripping element 246 are configured in such a way that they can absorb the spring force for a relatively long time without the gripping element 246 being deformed or even breaking.

### LIST OF REFERENCE SIGNS

100 vehicle seat
102 seat part
104 seat back
106 fitting
108 axis of rotation
110 longitudinal adjustment device
112 rail arrangement
114 first rail element (top rail)
114.1 top rail central section
114.2 top rail flank
114.3 top rail end section
114.4 recess
114.5 edge
116 second rail element (bottom rail)
116.1 bottom rail base
116.2 bottom rail flank
116.3 bottom rail end section
120 rail pair
122 track, in particular lower track
124 track, in particular upper track
200 sliding block
202 base part
204 mating gripping element
204.1 contact surface
204.2 contact surface
206 sliding block base
208 recess
208.1 side
208.2 lower side
210 sliding surface, in particular lower sliding surface
220 sliding surface, in particular upper sliding surface
222 contact region
230 wedge segment
232 wedge surface, mating wedge surface
234 film joint
240 wedge segment
242 wedge surface, mating wedge surface
244 attachment element
244.1 bending point
244.2 bending point
246 gripping element
246.1 contour
248 spring connection point
250 tooth system
252 vertical flank
254 tooth tip
256 wedge tooth
260 spring element
262 first spring leg
264 second spring leg
270 catch
280 hook element
300 arrow
302 arrow
304 arrow
400 four bar linkage
410 kinematics
420 lateral first solid body joint
430 lower second solid body joint
500 initial state
510 preloaded state
P1, P2 point
SE plane of symmetry
z1, z2 spacing
Fspring spring force
x, +x, −x longitudinal direction
y, +y, −y transverse direction
z, +z, −z vertical direction

What is claimed is:

1. A sliding block for a rail pair of a longitudinal adjustment device, comprising at least one base part having a lower sliding surface and an upper sliding surface, wherein at least one of the sliding surfaces comprises at least one flexible wedge segment arranged on the base part.

2. The sliding block as claimed in claim 1,
wherein the flexible wedge segment is designed as a wedge segment which is inherently resilient or is arranged resiliently on the base part.

3. The sliding block as claimed in claim 1,
wherein the flexible wedge segment has at least one contact region, which extends parallel to the longitudinal extent of the base part, and a wedge surface which lies opposite the contact region and runs obliquely to said contact region, and/or a wedge surface which adjoins said contact region and runs obliquely to said contact region.

4. The sliding block as claimed in claim 1,
wherein the flexible wedge segment is designed to be movable in the vertical extent of the base part and can be or is brought lockably into engagement on a corresponding wedge surface.

5. The sliding block as claimed in claim 1,
wherein a plurality of flexible wedge segments with mutually corresponding wedge surfaces are provided on the base part, and/or wherein at least two of the plurality of flexible wedge segments in each case are arranged so as to overlap with one another at least in some section or sections.

6. The sliding block as claimed in claim 5,
wherein the flexible wedge segments comprise mutually facing stepped and/or toothed wedge surfaces, which can be or are brought lockably into engagement with one another.

7. The sliding block as claimed in claim 5,
wherein the wedge surfaces of two flexible wedge segments are arranged one above the other in the vertical extent of the base part and/or so as to overlap at least in some section or sections.

8. The sliding block as claimed in claim 5,
wherein the flexible wedge segments are movable relative to one another in the vertical extent of the base part.

9. The sliding block as claimed in claim 5,
wherein one of the flexible wedge segments is designed to be movable in the longitudinal extent of the base part.

10. The sliding block as claimed in claim 9,
wherein the flexible wedge segment is held on the base part in a manner preloaded by a spring element in order to limit a movement in the longitudinal extent of the base part.

11. The sliding block as claimed in claim 5,
wherein the flexible wedge segments are each connected to the base part by a solid body joint.

12. The sliding block as claimed in claim 1,
wherein the base part is designed as a shaped body and has at least one upwardly open recess, on which at least one of the wedge segments is arranged as an upper flexible wedge segment projecting from one side of the recess.

13. The sliding block as claimed in claim 12,
wherein at least one of the wedge segments is arranged as a lower flexible wedge segment projecting from a lower side of the recess.

14. A rail pair comprising two rail elements and at least one sliding block as claimed in claim 1 arranged between the rail elements.
